(19) United States
(12) Patent Application Publication
(10) Pub. No.: US 2026/0244582 A1
(43) Pub. Date: Aug. 20, 2026

(54) Transaction Order Optimization For Improved Lane Utilization

(71) Applicant: Sandisk Technologies, Inc., Milpitas, CA (US)

(72) Inventors: Shay BENISTY, Beer Sheva (IL); Ariel NAVON, Revava (IL); Alexander BAZARSKY, Holon (IL); Judah Gamliel HAHN, Ofra (IL)

(73) Assignee: Sandisk Technologies, Inc., Milpitas, CA (US)

(21) Appl. No.: 19/055,372

(22) Filed: Feb. 17, 2025

(51) Int. Cl. G06F 13/16

(52) U.S. Cl. CPC G06F 13/1668

(57) ABSTRACT

For efficient operation, a data storage device can optimize usage of a link between the data storage device and a host device. The data storage device can change a lane configuration so that there are more transmission (Tx) lanes than receiving (Rx) lanes within a link. Similarly, the data storage device can change a lane configuration so that there are more receiving lanes than transmission lanes within the link. Additionally, the data storage device can activate and inactivate lanes within the link as needed. In so doing, the resulting lane configuration can be asymmetric such that there are unequal numbers of transmission and receiving lanes within the link. The lane configuration can be changed, and be asymmetric, in order to optimize power consumption and reduce latency.

### BACKGROUND OF THE DISCLOSURE

### Field of the Disclosure

Embodiments of the present disclosure generally relate to optimizing lane distribution.

### Description of the Related Art

Peripheral component interconnect (PCI) express (PCIe)/nonvolatile memory (NVM) express (NVMe) commands are submitted and completed using a series of queues. When input/output (I/O) commands are executed, the data storage device will perform direct memory access (DMA) transfers across the PCIe bus and then complete the command by writing to a completion queue in host memory. The DMA transfers utilize all available PCIe bandwidth.

Recent innovations in power management allow for PCIe bandwidth to be selectively optimized by reducing lane width and speed when the storage device is not actively using the bandwidth. The innovations include the PCIe Gen6 L0p feature, as well as previous implementations such as AMD’s PCIe speed power policy (PSPP) feature. However, current art does not selectively allow for asymmetric modification of the bandwidth, prioritizing the direction (read or write) and the required ratio between transmitting or transmission (Tx) and receiving or receipt (Rx) as to achieve maximal efficiency within a limited power envelope.

In terms of lane reconfiguration latency, once a determination is made to reduce the link width with L0p, the data storage device waits until the next SKP Ordered Set boundary (next pre-set window), which in the worst case will be 1.5 micro-seconds away. On the way to up-configuration, the latency is dependent on the design and the amount of aggressive power savings the device implements. The PCIe spec expects the number to be in the micro-seconds range. Thus, while there is a benefit of reconfiguring lanes, the latency can be an issue.

Therefore, there is a need in the art for optimizing lane configurations.

### SUMMARY OF THE DISCLOSURE

For efficient operation, a data storage device can optimize usage of a link between the data storage device and a host device. The data storage device can change a lane configuration so that there are more transmission (Tx) lanes than receiving (Rx) lanes within a link. Similarly, the data storage device can change a lane configuration so that there are more receiving lanes than transmission lanes within the link. Additionally, the data storage device can activate and inactivate lanes within the link as needed. In so doing, the resulting lane configuration can be asymmetric such that there are unequal numbers of transmission and receiving lanes within the link. The lane configuration can be changed, and be asymmetric, in order to optimize power consumption and reduce latency.

In one embodiment, a data storage device comprises: a memory device; and a controller coupled to the memory device, wherein the controller is configured to: determine current and future workloads for the data storage device; determine an optimal number of active lanes for the workloads; determine an optimal direction of the optimal number of active lanes for the workloads; and modify one or more of: a number of active lanes; or a direction of active lanes.

In another embodiment, a data storage device comprises: a memory device; and a controller coupled to the memory device, wherein the controller is configured to: determine a completion queue order that is out of order from a retrieval order from one or more submission queues, wherein the completion queue order reduces power consumption or reduced latency or both reduces power consumption and reduces latency compared to the retrieval order; change one or more lanes in a link between a host device and the data storage device, wherein the link comprises a plurality of lanes and wherein the changing results in an asymmetric number of transmission lanes and receiving lanes; and execute commands retrieved in the retrieval order and executed in the completion queue order.

In another embodiment, a data storage device comprises: means for storing data; and a controller coupled to the means for storing data, wherein the controller is configured to: change an order of command execution; change a lane configuration between the data storage device and a host device, wherein the lane configuration is changed to an asymmetric arrangement of transmission lanes and receiving lanes; and execute commands, wherein the controller comprises a completion queue control module, a workload analysis module, and a L0p modification control module.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a data storage device may function as a storage device for a host device, according to certain embodiments.

FIG. 2 is a block diagram of a system according to one embodiment.

FIG. 3 is a block diagram of a system according to another embodiment.

FIG. 4 is a flowchart illustrating a lane modification determination according to one embodiment.

FIG. 5 is a flowchart illustrating a lane modification determination according to one embodiment.

FIG. 6 is a flowchart illustrating a lane modification determination according to one embodiment.

FIG. 7 is a flowchart illustrating a lane modification determination according to one embodiment.

FIG. 8 is a flowchart illustrating a lane modification determination according to one embodiment.

FIG. 9 is a schematic illustration of a memory system having a four lane link according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

For efficient operation, a data storage device can optimize usage of a link between the data storage device and a host device. The data storage device can change a lane configuration so that there are more transmission (Tx) lanes than receiving (Rx) lanes within a link. Similarly, the data storage device can change a lane configuration so that there are more receiving lanes than transmission lanes within the link. Additionally, the data storage device can activate and inactivate lanes within the link as needed. In so doing, the resulting lane configuration can be asymmetric such that there are unequal numbers of transmission and receiving lanes within the link. The lane configuration can be changed, and be asymmetric, in order to optimize power consumption and reduce latency.

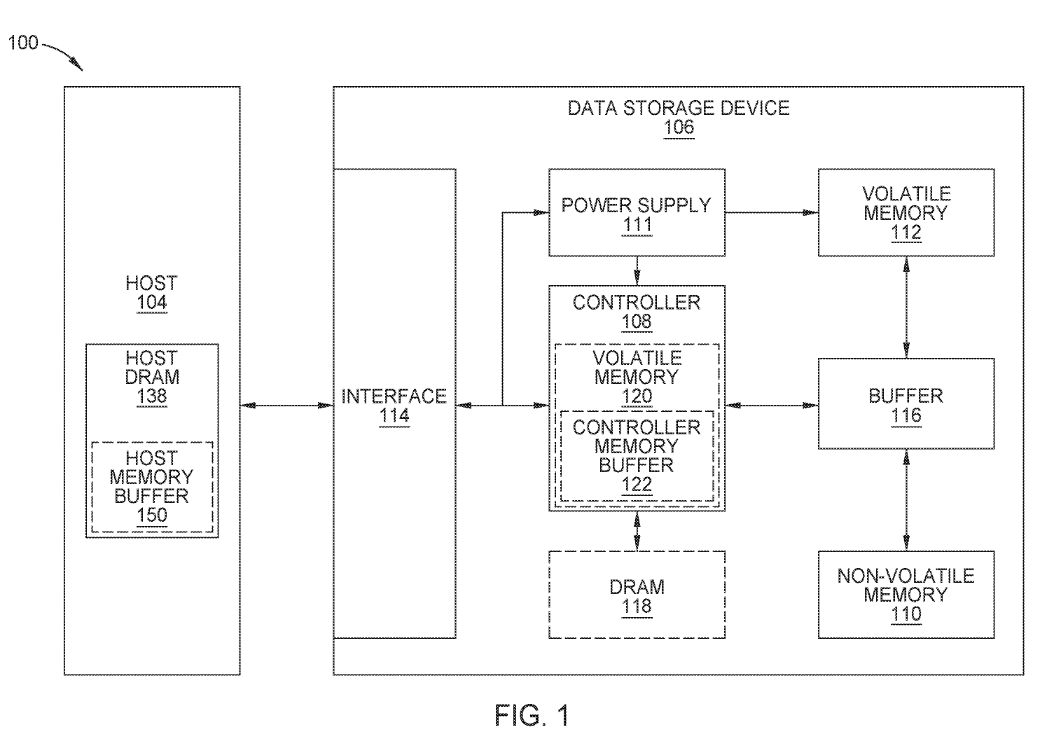

FIG. 1 is a schematic block diagram illustrating a storage system 100 having a data storage device 106 that may function as a storage device for a host device 104, according to certain embodiments. For instance, the host device 104 may utilize a non-volatile memory (NVM) 110 included in data storage device 106 to store and retrieve data. The host device 104 comprises a host dynamic random access memory (DRAM) 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The host DRAM 138 may optionally include a host memory buffer (HMB) 150. The HMB 150 is a portion of the host DRAM 138 that is allocated to the data storage device 106 for exclusive use by a controller 108 of the data storage device 106. For example, the controller 108 may store mapping data, buffered commands, logical to physical (L2P) tables, metadata, and the like in the HMB 150. In other words, the HMB 150 may be used by the controller 108 to store data that would normally be stored in a volatile memory 112, a buffer 116, an internal memory of the controller 108, such as static random access memory (SRAM), and the like. In examples where the data storage device 106 does not include a DRAM (i.e., optional DRAM 118), the controller 108 may utilize the HMB 150 as the DRAM of the data storage device 106.

The data storage device 106 includes the controller 108, NVM 110, a power supply 111, volatile memory 112, the interface 114, a write buffer 116, and an optional DRAM 118. In some examples, the data storage device 106 may include additional components not shown in FIG. 1 for the sake of clarity. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5” data storage device (e.g., an HDD or SSD), 2.5” data storage device, 1.8” data storage device, peripheral component interconnect (PCI), PCI-extended (PCI-X), PCI Express (PCIe) (e.g., PCIe x1, x4, x8, x16, PCIe Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like. Interface 114 (e.g., the data bus, the control bus, or both) is electrically connected to the controller 108, providing an electrical connection between the host device 104 and the controller 108, allowing data to be exchanged between the host device 104 and the controller 108. In some examples, the electrical connection of interface 114 may also permit the data storage device 106 to receive power from the host device 104. For example, as illustrated in FIG. 1, the power supply 111 may receive power from the host device 104 via interface 114.

The NVM 110 may include a plurality of memory devices or memory units. NVM 110 may be configured to store and/or retrieve data. For instance, a memory unit of NVM 110 may receive data and a message from controller 108 that instructs the memory unit to store the data. Similarly, the memory unit may receive a message from controller 108 that instructs the memory unit to retrieve data. In some examples, each of the memory units may be referred to as a die. In some examples, the NVM 110 may include a plurality of dies (i.e., a plurality of memory units). In some examples, each memory unit may be configured to store relatively large amounts of data (e.g., 128MB, 256MB, 512MB, 1GB, 2GB, 4GB, 8GB, 16GB, 32GB, 64GB, 128GB, 256GB, 512GB, 1TB, etc.).

In some examples, each memory unit may include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 may comprise a plurality of flash memory devices or memory units. NVM Flash memory devices may include NAND or NOR-based flash memory devices and may store data based on a charge contained in a floating gate of a transistor for each flash memory cell. In NVM flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVM cells. Rows of NVM cells may be electrically connected using a word line to define a page of a plurality of pages. Respective cells in each of the plurality of pages may be electrically connected to respective bit lines. Furthermore, NVM flash memory devices may be 2D or 3D devices and may be single level cell (SLC), multi-level cell (MLC), triple level cell (TLC), or quad level cell (QLC). The controller 108 may write data to and read data from NVM flash memory devices at the page level and erase data from NVM flash memory devices at the block level.

The power supply 111 may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The volatile memory 112 may be used by controller 108 to store information. Volatile memory 112 may include one or more volatile memory devices. In some examples, controller 108 may use volatile memory 112 as a cache. For instance, controller 108 may store cached information in volatile memory 112 until the cached information is written to the NVM 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)). Likewise, the optional DRAM 118 may be utilized to store mapping data, buffered commands, logical to physical (L2P) tables, metadata, cached data, and the like in the optional DRAM 118. In some examples, the data storage device 106 does not include the optional DRAM 118, such that the data storage device 106 is DRAM-less. In other examples, the data storage device 106 includes the optional DRAM 118.

Controller 108 may manage one or more operations of the data storage device 106. For instance, controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. Controller 108 may determine at least one operational characteristic of the storage system 100 and store at least one operational characteristic in the NVM 110. In some embodiments, when the data storage device 106 receives a write command from the host device 104, the controller 108 temporarily stores the data associated with the write command in the internal memory or write buffer 116 before sending the data to the NVM 110. Controller 108 may include circuitry or processors configured to execute programs for operating the data storage device 106.

The controller 108 may include an optional second volatile memory 120. The optional second volatile memory 120 may be similar to the volatile memory 112. For example, the optional second volatile memory 120 may be SRAM. The controller 108 may allocate a portion of the optional second volatile memory to the host device 104 as controller memory buffer (CMB) 122. The CMB 122 may be accessed directly by the host device 104. For example, rather than maintaining one or more submission queues in the host device 104, the host device 104 may utilize the CMB 122 to store the one or more submission queues normally maintained in the host device 104. In other words, the host device 104 may generate commands and store the generated commands, with or without the associated data, in the CMB 122, where the controller 108 accesses the CMB 122 in order to retrieve the stored generated commands and/or associated data.

As noted above, the data storage device can configure the link between the host device and the data storage device differently in order to increase the performance. For example, the data storage device can enter a low power state in order to have a better power over the link. With L0p, the data storage device can dynamically adjust with the number of active lanes in the system.

The problem addressed herein is how to optimize the performance and power while taking into account the current state of the link and the data that is to be transferred over the link to have better power and performance results. Previously, there was no command reordering based on the status of the link. The disclosure involves command reordering in the execution and in the data transfer while taking into account the current status of the link and the pending commands that are in the system. Based on the status and pending commands, have better power and performance results.

Currently, the L0p feature is defined in the PCIe standard and can have the same number of active lanes for Tx and for Rx. For example, if the maximum number of lanes is four, then there are up to four lanes for Tx and up to four lanes for Rx. If the data storage device decides to reduce the number of lanes, the data storage device cannot have, for example, four lanes for Tx and just two lanes for Rx. Such would be asymmetric mode which is not supported today by the PCIe standard, but is anticipated to be supported by the PCIe standard in the near future. Until the PCIe standard supports asymmetric lanes, if the data storage device decides to reduce the number of lanes to two, the number of lanes would be the same for Tx and Rx. For the disclosure, assume asymmetric mode is supported by the PCIe standard.

As one example, if there is a read workload running in the system, such as for artificial intelligence (AI) purposes, there is an intensive read workload. Due to the intensive read workload, the data storage device needs to read a lot of data from the memory device and write the read data to the host device. Therefore, increasing the number of Tx lanes and reducing the number of Rx lanes would be beneficial because most of the traffic would be Tx on the link interface.

Most of the time, the data storage device needs to write lots of data to the host device and thus just need to process the read command. Assume for the example that processing read commands is the workload and then from time to time the host device also has write commands. Also, assume a lane configuration of just one active lane for Rx and one pending command.

If the data storage device needs to write data to the memory device, the controller needs to read something from the host interface. For the current example, there is only one port with one lane on the host interface for the Rx side. However, there is a pending write command and many other pending read commands in the system. So in the specific example, the controller may decide to reorder the command execution and prioritize read commands until there is another write command and then execute the write commands to achieve better performance. For the write commands, the controller will need to increase the number of lanes for the Rx, and it is better to aggregate write commands and not switch lane configurations frequently because switching takes time. So the idea at a very high level is to support the workloads that are in the system but take into account the status of the lanes and minimize the switching of the number of lanes. The motivation is to minimize the switches in order to have better performance, better power, and so on. The process involves taking into account the current state of the link, the pending commands that are in the device controller, and the expectation or prediction of when the host device will send the next read or write commands in the system. The controller will thus determine the best point in time to, for example, increase the number of active lanes and/or to switch lanes from Rx to Tx and vice versa.

Discussed herein are methods to improve the order of the completion queue to optimize the power consumption and reduce the latency overhead of active lane polarity modification. As part of the embodiments, a system is described that includes a data storage device and a host device that proposes a new PCIe asymmetric L0p feature, allowing a non-equal number of active lanes per Rx and Tx. More specifically, the number of lanes in a link can be modified according to the expected workload in order to optimize performance, power consumption, and reconfiguration latency.

As an example, if a “burst” throughput elevation is used in reading an AI model from a memory device (e.g., NAND), turning most lanes to Tx would improve the performance at the expense of power consumption. Previously, storage command execution order would not consider the active lane number and direction. Additionally, an equal number of lanes were required for Rx and Tx, such that a reduction of the number of lanes was possible, but would be identical for Rx and Tx. The main goal of the reduction feature was to reduce the power consumption when the data storage device was not in full interaction.

The disclosure involves improving transfer ordering to optimize, for a given power envelope, asymmetric lane counts for optimizing transfers. The controller orders the transactions in an NVMe completion queue to optimize the power consumption and reduce the latency overhead of active lane number modification. As part of the disclosure there is also described a system that includes a storage device and a host device, utilizing and extending the new PCIe 6.0 L0p feature, modifying the number of lanes according to the expected workload in order to optimize performance, power consumption and latency. It should be noted that the asymmetric L0p is a feature under discussion in the standards and the disclosure assumes that the feature will eventually be developed and standardized. The proposed system will estimate the current completion rate and the expected completion queue population in the completion queue control module, and reorder command execution and completion in a way that reduces the number of switches to the active lane number and corresponding polarity.

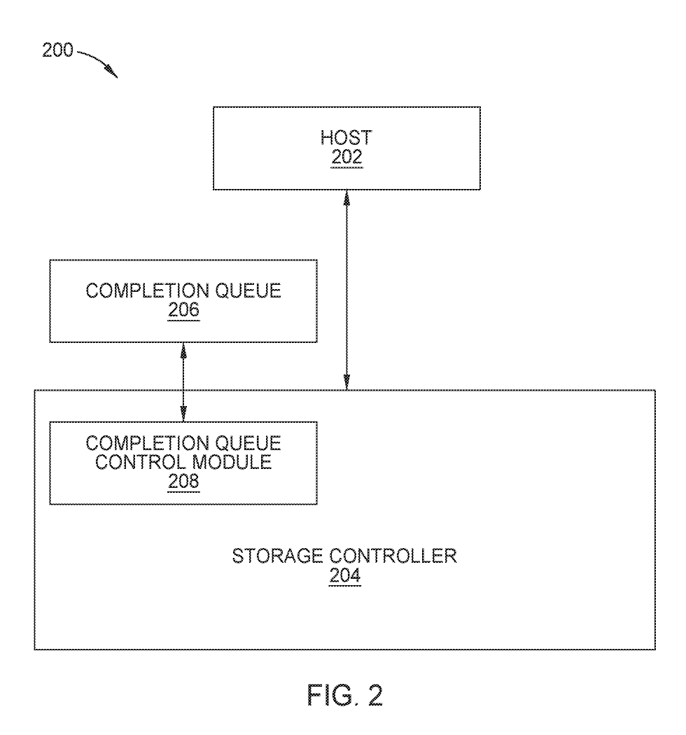

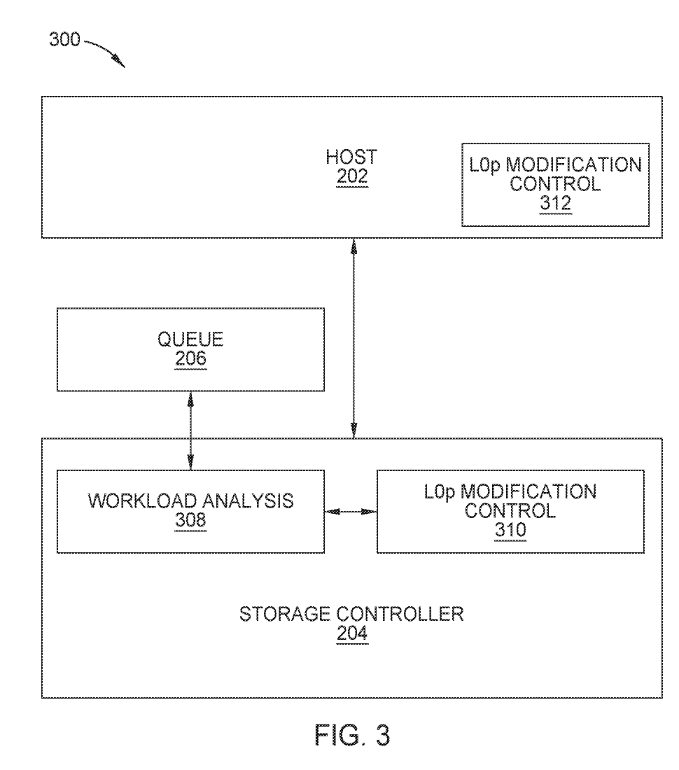

FIG. 2 is a block diagram of a system according to one embodiment. FIG. 3 is a block diagram of the system of FIG. 2 adding additional components. As shown in FIGS. 2 and 3, there is a host device 202 and storage controller 204. FIGS. 2 and 3 additionally show a completion queue 206. FIG. 2 also shows a completion queue control module 208 disposed in the storage controller 204. The completion queue 206 is for when the controller needs to send the host device 202 the completions. The controller 204 we may decide to reorder the command executions based on the current status of the link and the expectation of the next workloads that are expected in the system 200.

In one embodiment, command execution order and completion may be modified along with the number of active lanes according to workloads, the power consumption and requested throughput, also considering the reconfiguration latency. FIG. 3 shows a workload analysis module 308. There is an L0p modification control module 310 in the storage controller 204 and another L0p modification control module 312 in the host device. The workload analysis module 308 predicts what the next workload may be, which leads to a determination that it would be better to aggregate more and more commands, especially write commands, before executing the write commands. There will be interaction with the L0p modification control module 310 which decides when to increase the number of lanes or maybe reduce the number of lanes on the interface. The number of lanes will depend on the current workload in the system 300.

In FIG. 3, the workload analysis module 308 in the storage controller 204 monitors the current and expected workload, the power consumption, and requested throughput. The workload analysis module 308 then transfers the determined information to the L0p modification control module 310 in the storage controller 204. Transactions that access host memory can then be ordered with the workload and configuration in mind.

The L0p modification control module 310 analyzes the overall conditions that do not include the workload (i.e., the power consumption, throughput required by host, and/or special priority cases). The L0p modification control module 310 also considers the reconfiguration latency and determines whether a change to the lane configuration is beneficial. According to the decision, the L0p modification control module 310 initiates handshake with the host device 202 L0p modification control module 312 and the change is scheduled to the next switching window.

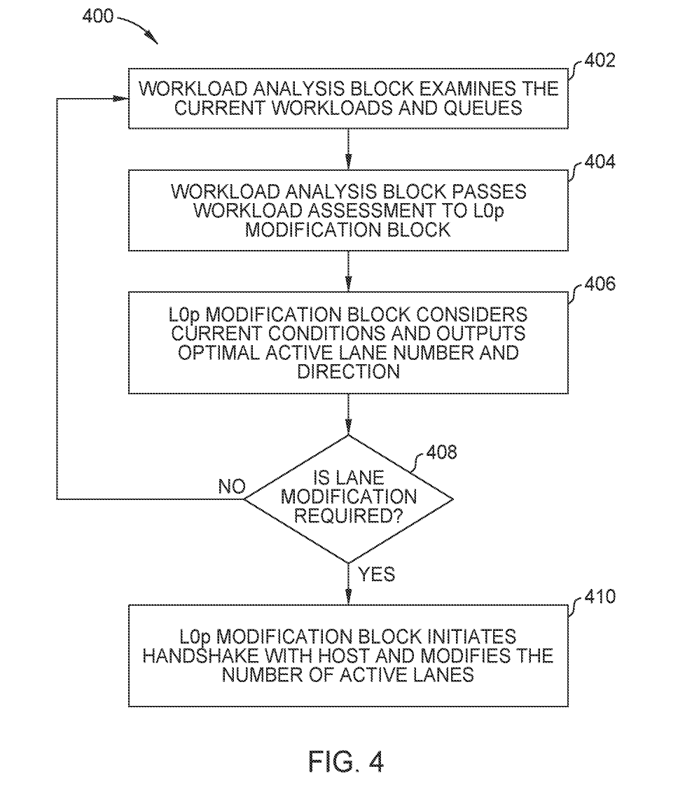

FIG. 4 is a flowchart 400 illustrating a lane modification determination according to one embodiment. Initially, there is a time lapse or workload change detected. The workload analysis module will examine the current and future workloads in the queues at block 402 and interact with the L0p modification control module at block 404 that considers the current conditions. The output would be the optimal active lane number and direction in the L0p asymmetric feature that is the best to work with at block 406. In this case, the controller may decide to wait on the switch for some time and do the modification not now, but in one second from now, for example. In the meanwhile, the controller will reorder the command execution in order to maximize the window. If the modification is required at block 408, then the controller will interact with the host device in order to make the switch at block 410.

The original goal of L0p was to reduce the number of active lanes in order to save power when the lanes are not needed. However, the number of Tx lanes was equal to the number of Rx. The instant disclosure leverages a proposed extension to L0p that enables asymmetric use of Tx and Rx lanes to optimize bandwidth while saving power. For example, when a large language model (LLM) is read from the memory device (i.e., flash) to be used for inference through the host DRAM, the read volume is very large, and the LLM is needed as fast as possible.

In another example, for an LLM which is an AI workload that is write intensive, from time to time the controller will have the write back for the update. Thus, the writes that are present may be more beneficially processed if aggregated and then executed all at once in order to minimize the number of switches in the link. If the extra power consumption is allowed, the system can utilize the disclosure and thus increase the number of active Tx lanes.

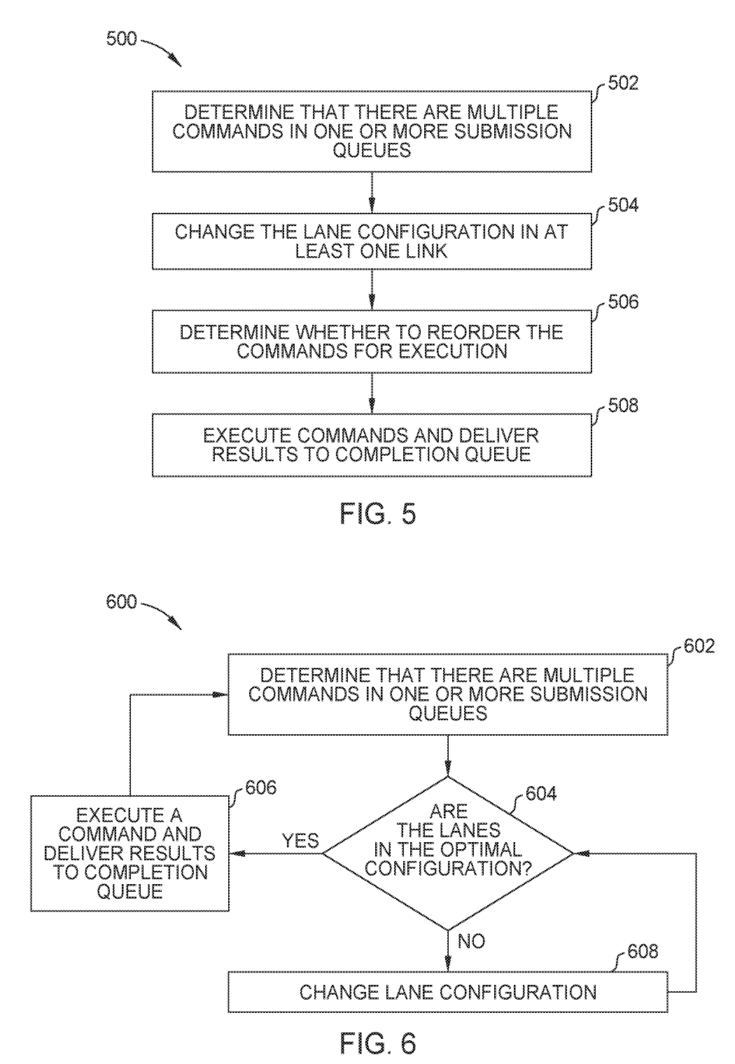

FIG. 5 is a flowchart 500 illustrating a lane modification determination according to one embodiment. Initially, the controller determines that there are multiple commands in one or more submission queues at block 502 and changes the lane configuration in at least one link 504 based upon what is present in the submission queues. The controller also determines whether to reorder the commands for execution at block 506 and then executes the commands and delivers the results to a completion queue at block 508 and then repeats the process.

FIG. 6 is a flowchart 600 illustrating a lane modification determination according to one embodiment. Initially, the controller determines that there are multiple commands in one or more submission queues at block 602 and then makes a determination regarding whether the current lane configuration is optimal at block 604. If not optimal, then the lane configuration is changed at block 608, but if optimal, then a command is executed and results delivered to a completion queue at block 606 followed by repeating the process.

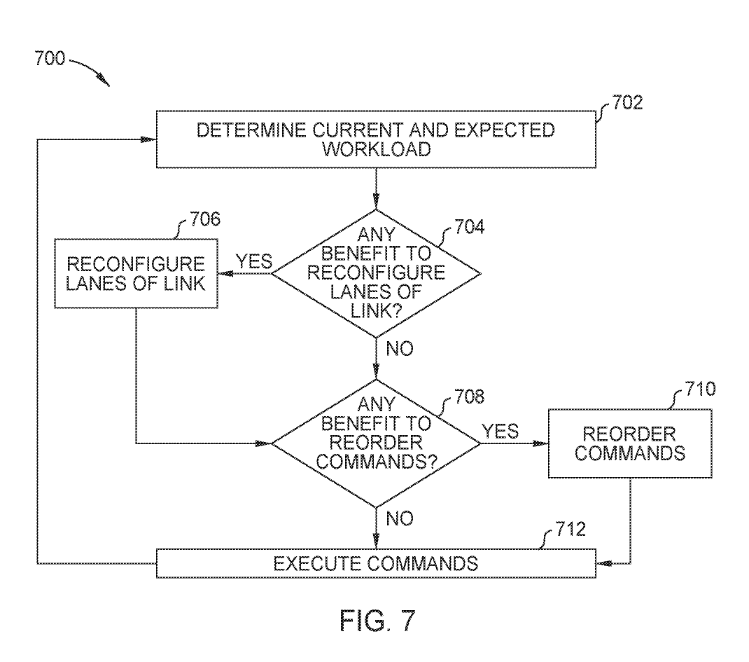

FIG. 7 is a flowchart 700 illustrating a lane modification determination according to one embodiment. Initially, the controller determines the current and expected workload at block 702. If there is no benefit to reconfiguring the lanes in the link at block 704, then there is a determination of whether there is any benefit to reordering the commands are block 708. If there is a benefit to reconfiguring the lanes in the link at block 704, then the lanes are reconfigured at block 706 followed by the determination at block 708. If there is a benefit at block 708, then the commands are reordered at block 710 followed by execution of the commands at block 712 and repetition of the process. If there is no benefit to reordering the commands at block 708, then the process continues to block 712. It is to be noted that blocks 704 and 708, and hence blocks 706 and 710, may occur in any order or even simultaneously.

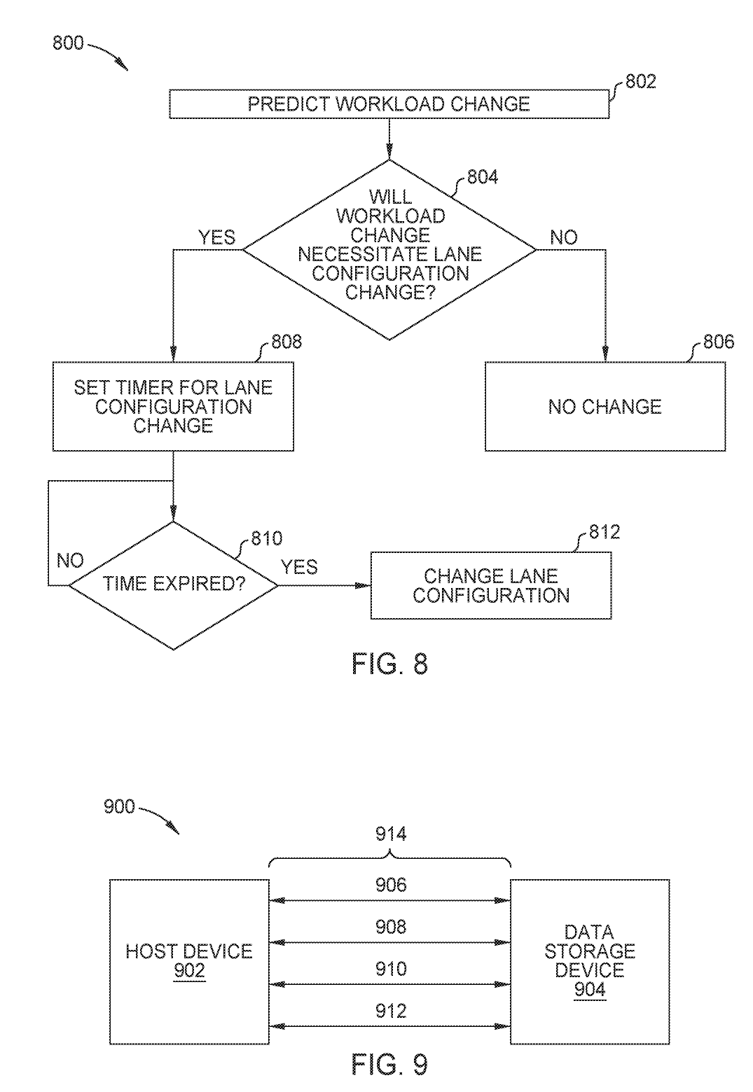

FIG. 8 is a flowchart 800 illustrating a lane modification determination according to one embodiment. In FIG. 8, the lane modification can be scheduled to occur at a later point in time as the workload is expected to change due to future commands in the queue, and the conditions such as power consumption and read latency are considered. In the scenario, the L0p modification block will set a timer to send the lane modification command at a later time, which is most probably within several microseconds or tens of microseconds. More specifically, the lane modification timing may be that it would be better to switch to increase, for example, the number of lanes later because the controller detects that there is a point where the workload will increase and be more write intensive. So based on that, the controller will decide what would be the timing to do the modification.

At block 802, the controller predicts a workload change and then makes a determination at block 804 regarding whether the workload change will necessitate a lane configuration change. If no, then there is no change at block 806. If yes at block 804, then a timer is set at block 808 while waiting for the timer to expire at block 810. Once the timer expires, then the lane configuration is changed at block 812.

FIG. 9 is a schematic illustration of a memory system 900 having a four lane link 914 according to one embodiment. In the memory system 900, there is a host device 902 coupled to a data storage device 904. There is a single link 914 shown in FIG. 9 that has four lanes 906, 908, 910, 912. Based upon the asymmetric lane configuration, any combination of lanes is possible such as lane 906 being Rx and lanes 908, 910, 912 being Tx...and vice versa. A symmetric lane configuration is also possible.

In operation, the controller in the data storage device 904 will fetch commands from one or more submission queues that may be located either within the host device 902 or within the data storage device 904, such as within CMB. Based upon the fetching, the commands will be in a retrieved or fetched order, which is the default expectation for execution order. The controller will then analyze the retrieved commands and do several things. One thing the controller will do is to determine or predict what additional commands will follow. For example, whether more read or write commands will follow. Additionally, the controller will determine the power consumption to execute the commands, when the lane configuration should change to execute the commands in the retrieved order, and latency for lane configuration changes. The controller will then decide whether to start executing the commands, reorder the commands into a more efficient order, or wait to execute the commands. Based upon the decision, the controller will set the optimal lane configuration for the link, which may be asymmetrical between Rx and Tx and begin executing or waiting (and then executing).

By reordering the execution of host transfers, power consumption is reduced while maintaining throughput.

In one embodiment, a data storage device comprises: a memory device; and a controller coupled to the memory device, wherein the controller is configured to: determine current and future workloads for the data storage device; determine an optimal number of active lanes for the workloads; determine an optimal direction of the optimal number of active lanes for the workloads; and modify one or more of: a number of active lanes; or a direction of active lanes. The direction of active lanes is asymmetric in number. The controller is configured to reorder commands retrieved from a submission queue. The controller is configured to determine a time to perform the modifying. The controller is configured to set a timer after the determining a time. The controller includes a completion queue control module, a workload analysis module, and an L0p modification control module. The controller is configured to return executed commands to a completion queue out of order from which commands were received in a submission queue. The controller is configured to determine that a read volume will be greater than a threshold and wherein the controller is configured to increase a number of transmission lanes based upon the determining. The number of transmission lanes is asymmetric to a number of receiving lanes within a link. The controller is configured to order transactions in a completion queue to optimize power consumption and reduce latency.

In another embodiment, a data storage device comprises: a memory device; and a controller coupled to the memory device, wherein the controller is configured to: determine a completion queue order that is out of order from a retrieval order from one or more submission queues, wherein the completion queue order reduces power consumption or reduced latency or both reduces power consumption and reduces latency compared to the retrieval order; change one or more lanes in a link between a host device and the data storage device, wherein the link comprises a plurality of lanes and wherein the changing results in an asymmetric number of transmission lanes and receiving lanes; and execute commands retrieved in the retrieval order and executed in the completion queue order. The controller is configured to monitor current and expected workloads for the data storage device. The controller comprises a L0p modification control module that is configured to initiate a handshake with a host device L0p modification control module. The controller L0p modification control module analyzes overall conditions that do not include a workload. The overall conditions that do not include the workload comprise power consumption and throughput expected by the host device. The overall conditions that do not include the workload comprise reconfiguration latency and is configured to determine whether to change a lane configuration of the link. The controller is configured to estimate current completion rate and expected completion queue population in a completion queue control module.

In another embodiment, a data storage device comprises: means for storing data; and a controller coupled to the means for storing data, wherein the controller is configured to: change an order of command execution; change a lane configuration between the data storage device and a host device, wherein the lane configuration is changed to an asymmetric arrangement of transmission lanes and receiving lanes; and execute commands, wherein the controller comprises a completion queue control module, a workload analysis module, and a L0p modification control module. The L0p modification control module determines the lane configuration based upon the changed order of command execution. The workload analysis module examines current and future workloads in one or more submission queues, and wherein the completion queue control module estimates current completion rate and expected completion queue population.

While the foregoing is directed to embodiments of the present disclosure, other and further embodiments of the disclosure may be devised without departing from the basic scope thereof, and the scope thereof is determined by the claims that follow.

What is claimed is:

1. A data storage device, comprising:
a memory device; and
a controller coupled to the memory device, wherein the controller is configured to:
determine current and future workloads for the data storage device;
determine an optimal number of active lanes for the workloads;
determine an optimal direction of the optimal number of active lanes for the workloads; and
modify one or more of:
a number of active lanes; or
a direction of active lanes.

2. The data storage device of claim 1, wherein the direction of active lanes is asymmetric in number.

3. The data storage device of claim 1, wherein the controller is configured to reorder commands retrieved from a submission queue.

4. The data storage device of claim 1, wherein the controller is configured to determine a time to perform the modifying.

5. The data storage device of claim 4, wherein the controller is configured to set a timer after the determining a time.

6. The data storage device of claim 1, wherein the controller includes a completion queue control module, a workload analysis module, and an L0p modification control module.

7. The data storage device of claim 1, wherein the controller is configured to return executed commands to a completion queue out of order from which commands were received in a submission queue.

8. The data storage device of claim 1, wherein the controller is configured to determine that a read volume will be greater than a threshold and wherein the controller is configured to increase a number of transmission lanes based upon the determining.

9. The data storage device of claim 8, wherein the number of transmission lanes is asymmetric to a number of receiving lanes within a link.

10. The data storage device of claim 1, wherein the controller is configured to order transactions in a completion queue to optimize power consumption and reduce latency.

11. A data storage device, comprising:
a memory device; and
a controller coupled to the memory device, wherein the controller is configured to:
determine a completion queue order that is out of order from a retrieval order from one or more submission queues, wherein the completion queue order reduces power consumption or reduced latency or both reduces power consumption and reduces latency compared to the retrieval order;
change one or more lanes in a link between a host device and the data storage device, wherein the link comprises a plurality of lanes and wherein the changing results in an asymmetric number of transmission lanes and receiving lanes; and
execute commands retrieved in the retrieval order and executed in the completion queue order.

12. The data storage device of claim 11, wherein the controller is configured to monitor current and expected workloads for the data storage device.

13. The data storage device of claim 11, wherein the controller comprises an L0p modification control module that is configured to initiate a handshake with a host device L0p modification control module.

14. The data storage device of claim 13, wherein the controller L0p modification control module analyzes overall conditions that do not include a workload.

15. The data storage device of claim 14, wherein the overall conditions that do not include the workload comprise power consumption and throughput expected by the host device.

16. The data storage device of claim 15, wherein the overall conditions that do not include the workload comprise reconfiguration latency and is configured to determine whether to change a lane configuration of the link.

17. The data storage device of claim 11, wherein the controller is configured to estimate current completion rate and expected completion queue population in a completion queue control module.

18. A data storage device, comprising:
means for storing data; and
a controller coupled to the means for storing data, wherein the controller is configured to:
change an order of command execution;
change a lane configuration between the data storage device and a host device, wherein the lane configuration is changed to an asymmetric arrangement of transmission lanes and receiving lanes; and
execute commands, wherein the controller comprises a completion queue control module, a workload analysis module, and a L0p modification control module.

19. The data storage device of claim 18, wherein the L0p modification control module determines the lane configuration based upon the changed order of command execution.

20. The data storage device of claim 18, wherein the workload analysis module examines current and future workloads in one or more submission queues, and wherein the completion queue control module estimates current completion rate and expected completion queue population.
